(19) United States
(12) Patent Application Publication
(10) Pub. No.: US 2014/0045531 A1
(43) Pub. Date: Feb. 13, 2014

(54) PORTABLE-DEVICE POSITION DETERMINATION SYSTEM, PORTABLE-DEVICE POSITION DETERMINATION METHOD, AND PORTABLE-DEVICE POSITION DETERMINATION APPARATUS

(71) Applicants: Kenichi Kessoku, Aichi (JP); Tadao Nishiguchi, Aichi (JP); Yutaka Yasuda, Aichi (JP); Yusuke Ueda, Aichi (JP); Shuji Yamashita, Aichi (JP)

(72) Inventors: Kenichi Kessoku, Aichi (JP); Tadao Nishiguchi, Aichi (JP); Yutaka Yasuda, Aichi (JP); Yusuke Ueda, Aichi (JP); Shuji Yamashita, Aichi (JP)

(73) Assignee: OMRON AUTOMOTIVE ELECTRONICS CO., LTD., Aichi (JP)

(21) Appl. No.: 13/962,099

(22) Filed: Aug. 8, 2013

(30) Foreign Application Priority Data
Aug. 8, 2012 (JP) 2012-175798

(51) Int. Cl. H04W 4/04

(52) U.S. Cl. CPC H04W 4/046
USPC 455/456.2

(57) ABSTRACT

A portable-device position determination system has a portable device that is configured to be possessed by a user, and an in-vehicle device that is mounted on a vehicle and conducts wireless communication with the portable device. The in-vehicle device transmits a request signal to the portable device. The portable device detects a received signal intensity of the request signal to send back the received signal intensity to the in-vehicle device. The in-vehicle device compares the received signal intensity of the request signal detected by the portable device to a threshold to determine a position of the portable device. The in-vehicle device includes a transmission controller that generates the request signal, supplies an electric power to a transmitting antenna, and transmits the request signal from the transmitting antenna, and a current detector that detects a current passed through the transmitting antenna when the request signal is transmitted.

### BACKGROUND

1. Technical Field

The present invention relates to a technology for determining a position of a portable device with an in-vehicle device that conducts wireless communication with the portable device.

2. Related Art

In a vehicle system in which wireless communication is automatically conducted between a portable device possessed by a user and an in-vehicle device mounted on a vehicle, a position of the portable device is determined with respect to the vehicle in order to improve convenience. Locking/unlocking of a door of the vehicle and control of engine starting are restricted according to the position of the portable device.

For example, in Japanese Unexamined Patent Publication No. 2011-163764, a plurality of antennas are installed inside and outside the vehicle. When driving the antenna by an initial electric power, the in-vehicle device detects a current passed through the antenna, sets an electric power supplied to the antenna based on the detected current, and generates a magnetic field. The portable device measures the magnetic field of the antenna, compares the measured value to a nominal magnetic field, and determines whether the portable device itself is located within a surrounding range of the antenna.

In Japanese Unexamined Patent Publication No. 2010-280385, the in-vehicle device transmits a request signal, and the portable device receives the request signal to detect a received signal intensity of the request signal. The portable device compares the received signal intensity to a threshold, the portable device transmits an interior code when the received signal intensity is greater than the threshold, and the portable device transmits an exterior code when the received signal intensity is less than or equal to the threshold. When receiving the interior code, the in-vehicle device determines that the portable device is located in the vehicle, and permits the engine starting. When receiving the exterior code, the in-vehicle device determines that the portable device is located outside the vehicle, and locks the door.

In Japanese Unexamined Patent Publication No. 2011-144624, a signal (radio wave) is sequentially transmitted from the plurality of antennas provided in the vehicle, the portable device detects the received signal intensity of the signal from each antenna, and transmits the received signal intensity to the vehicle side. The in-vehicle device multiplies the received signal intensity of the signal of each antenna by a coefficient, calculates an intensity difference, and determines whether the portable device is located inside or outside the vehicle based on the intensity difference.

When the signal is transmitted from the vehicle-side antenna, the current passed through the antenna from a current supply circuit changes according to ambient temperature as illustrated in FIG. 12. The current passed through the antenna also changes according to a characteristic and accuracy of the antenna or a circuit element.

When the current passed through the antenna increases by physical factors such as the temperature condition and the component characteristic as illustrated in FIG. 13A, am electric field intensity of the signal transmitted from the antenna increases, and the received signal intensity of the signal detected by the portable device also increases during the reception of the signal. When the current passed through the antenna decreases as illustrated in FIG. 13B, the electric field intensity of the signal transmitted from the antenna decreases, and the received signal intensity of the signal detected by the portable device also decreases during the reception of the signal.

Possibly the position of the portable device is mistakenly determined when the current passed through the antenna changes by the physical factors to vary the received signal intensity of the signal detected by the portable device. For example, even if a distance D between the vehicle-side antenna and the portable device does not vary as illustrated in FIGS. 13A and 13B, the in-vehicle device determines that the portable device exists in the vehicle in FIG. 13A, and determines that the portable device exists outside the vehicle in FIG. 13B.

In the case that the determination whether the portable device exists in the vehicle or outside the vehicle is mistakenly made, for example, when the door of the vehicle is automatically locked or unlocked, possibly the door is locked while the portable device exists in the vehicle, and the portable device is locked away in the vehicle.

### SUMMARY

One or more embodiments of the present invention improves accuracy of portable-device position determination.

In accordance with one aspect of the present invention, a portable-device position determination system includes: a portable device that is possessed by a user; and an in-vehicle device that is mounted on a vehicle and conducts wireless communication with the portable device, wherein the in-vehicle device transmits a request signal to the portable device, the portable device detects a received signal intensity of the request signal to send back the received signal intensity to the in-vehicle device, the in-vehicle device compares the received signal intensity of the request signal detected by the portable device to a threshold to determine a position of the portable device, the in-vehicle device includes: a transmission controller that generates the request signal, supplies an electric power to a transmitting antenna, and transmits the request signal from the transmitting antenna; a current detector that detects a current passed through the transmitting antenna when the request signal is transmitted; and a threshold changing part that changes the threshold based on the current detected by the current detector.

In accordance with another aspect of the present invention, a portable-device position determination method in which an in-vehicle device mounted on a vehicle conducts wireless communication with a portable device possessed by a user to transmit a request signal to the portable device, the portable device detecting a received signal intensity of the request signal to send back the received signal intensity to the in-vehicle device, and the in-vehicle device comparing the received signal intensity of the request signal detected by the portable device to a threshold to determine a position of the portable device, wherein the in-vehicle device generates the request signal, supplies an electric power to a transmitting antenna, and transmits the request signal from the transmitting antenna, detects a current passed through the transmitting antenna when the request signal is transmitted, and changes the threshold based on the detected current.

In accordance with still another aspect of the present invention, a portable-device position determination apparatus that is of an in-vehicle device mounted on a vehicle, the portable-device position determination apparatus conducting wireless communication with a portable device possessed by a user to transmit a request signal to the portable device, receiving a received signal intensity of the request signal detected by the portable device from the portable device, and comparing the received signal intensity to a threshold to determine a position of the portable device, the portable-device position determination apparatus includes: a transmission controller that generates the request signal, supplies an electric power to a transmitting antenna, and transmits the request signal from the transmitting antenna; a current detector that detects a current passed through the transmitting antenna when the request signal is transmitted; and a threshold changing part that changes the threshold based on the current detected by the current detector.

Even if the current passed through the transmitting antenna changes due to the physical factors to vary the received signal intensity of the request signal detected by the portable device, the received signal intensity is compared to the threshold that is changed according to the current of the transmitting antenna. The position of the portable device is determined by the comparison result, so that the accuracy of the portable-device position determination can be improved.

In one or more embodiments of the present invention, the transmitting antennas may be installed inside and outside the vehicle, the transmission controller may supply the electric power to each of the transmitting antennas, and transmit the request signal from each of the transmitting antennas in different timing, the current detector may detect the current passed through each of the transmitting antennas when the request signal is transmitted from each of the transmitting antennas, and the threshold changing part may change the threshold in each of the transmitting antennas based on the current detected by the current detector. The portable device may detect the received signal intensity of the request signal transmitted from each of the transmitting antennas, and send back the received signal intensity to the in-vehicle device while correlating the received signal intensity with each of the transmitting antenna, and the in-vehicle device may further include a determination part that compares the received signal intensity of the request signal to the threshold in each of the transmitting antennas to determine whether the portable device exists inside or outside the vehicle.

In one or more embodiments of the present invention, the current detector may detect the current passed through each of the transmitting antennas every time the request signal is transmitted from each of the transmitting antennas.

In one or more embodiments of the present invention, the current detector may detect a maximum value of the current passed through the transmitting antenna during the transmission of the request signal, and the threshold changing part may change the threshold based on the maximum value of the current detected by the current detector.

According to one or more embodiments of the present invention, the accuracy of the portable-device position determination can be improved.

### BRIEF DESCRIPTION OF THE DRAWINGS

FIG. 1 is a view illustrating a configuration of a portable-device position determination system according to an embodiment of the present invention;

FIG. 2 is a view illustrating an installation position of an antenna of an in-vehicle device in FIG. 1;

FIG. 3 is a view illustrating signal transmission timing of the in-vehicle device and a portable device in FIG. 1;

FIGS. 4A and 4B illustrate a signal transmitted from a transmitting antenna of the in-vehicle device in FIG. 1 and a current measurement point;

FIG. 5 is a view illustrating a threshold table retained by the in-vehicle device in FIG. 1;

FIG. 6 is a view illustrating a threshold retained by the in-vehicle device in FIG. 1;

FIG. 7 is a flowchart illustrating a portable-device position determination procedure performed by the in-vehicle device in FIG. 1;

FIG. 8 is a flowchart illustrating a portable-device vehicle interior existence determination procedure performed by the in-vehicle device in FIG. 1;

FIG. 9 is a flowchart illustrating a portable-device vehicle exterior existence determination procedure performed by the in-vehicle device in FIG. 1;

FIG. 10 is a view illustrating signal transmission timing of an in-vehicle device and a portable device according to another embodiment;

FIGS. 11A, 11B, and 11C illustrate a signal transmitted from a transmitting antenna of the in-vehicle device of another embodiment and current measurement points;

FIG. 12 is a view illustrating a relationship between ambient temperature and a current that is passed during transmission of a signal of a vehicle-side antenna; and

FIGS. 13A and 13B illustrate a signal transmission state of the vehicle-side antenna.

### DETAILED DESCRIPTION

Hereinafter, embodiments of the present invention will be described with reference to the drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention. In the drawings, similar components are designated by the identical numerals.

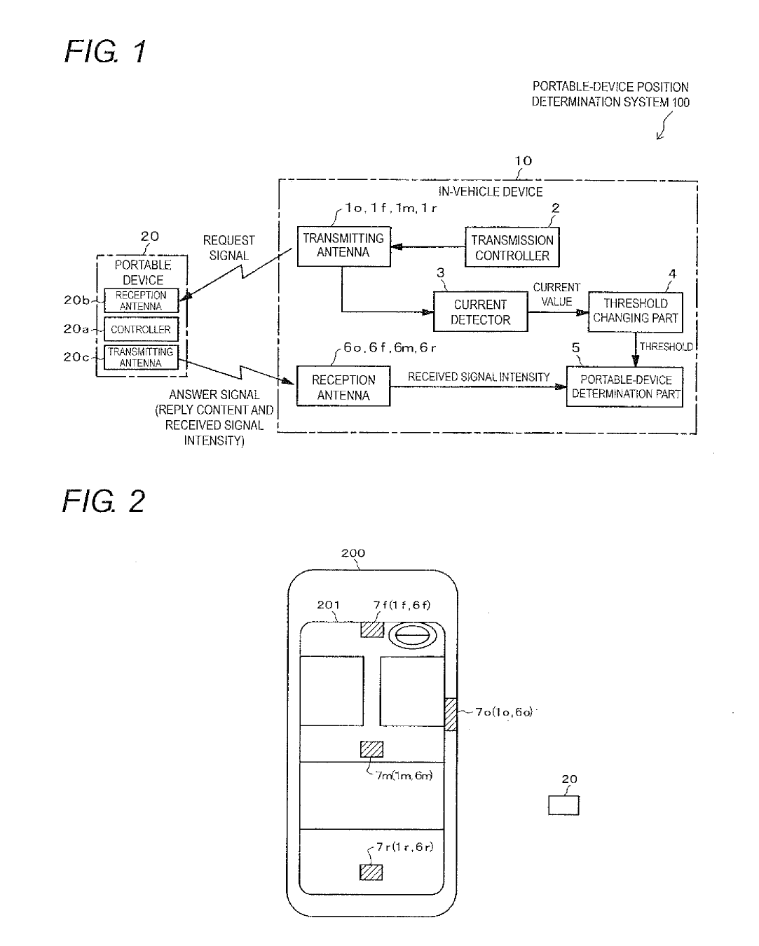

A configuration of a portable-device position determination system 100 of according to one or more embodiments of the present invention will be described with reference to FIGS. 1 and 2.

FIG. 1 is a view illustrating the configuration of the portable-device position determination system 100. The position determination system 100 is configured with a portable device 20 possessed by a user and an in-vehicle device 10 mounted on a vehicle 200 (see FIG. 2). For example, the portable device 20 is configured with an FOB key. The in-vehicle device 10 conducts wireless communication with the portable device 20 to determine a position of the portable device 20 with respect to the vehicle 200. The in-vehicle device 10 is an example of the “portable-device position determination apparatus” according to one or more embodiments of the present invention.

The in-vehicle device 10 includes transmitting antennas 1o, 1f, 1m, and 1r, a transmission controller 2, a current detector 3, a threshold changing part 4, a portable-device determination part 5, and reception antennas 6o, 6f, 6m, and 6r. The portable device 20 includes a controller 20a, a reception antenna 20b, and a transmitting antenna 20c.

FIG. 2 is a view illustrating installation positions of antennas 1o, 1f, 1m, 1r, 6o, 6f, 6m, and 6r of the in-vehicle device 10. A plurality of antenna units 7o, 7f, 7m, and 7r are installed inside and outside a vehicle interior 201 of the vehicle 200.

The transmitting antenna 1o and the reception antenna 6o are incorporated in the antenna unit 7o that is installed outside the vehicle interior 201 on a driver seat side of the vehicle 200. The transmitting antenna if and the reception antenna 6f are incorporated in the antenna unit 7f installed in a front portion of the vehicle interior 201. The transmitting antenna 1m and the reception antenna 6m are incorporated in the antenna unit 7m installed in the center of the vehicle interior 201. The transmitting antenna 1r and the reception antenna 6r are incorporated in the antenna unit 7r which is installed in a rear portion of the vehicle interior 201.

Each of the transmitting antennas 1o, 1f, 1m, and 1r of the in-vehicle device 10 transmits an LF (Low Frequency) signal to the portable device 20. The reception antenna 20b of the portable device 20 receives the LF signal transmitted from the in-vehicle device 10. The transmitting antenna 20c of the portable device 20 transmits a UHF (Ultra High Frequency) signal to the in-vehicle device 10. Each of the reception antennas 6o, 6f, 6m, and 61 of the in-vehicle device 10 receives the UHF signal transmitted from the portable device 20.

The transmission controller 2 of the in-vehicle device 10 in FIG. 1 is configured with a microcomputer and a current supply circuit. The current detector 3, the threshold changing part 4, and the portable-device determination part 5 are configured with the microcomputer.

The transmission controller 2 generates a request signal to the portable device 20. The transmission controller 2 supplies an electric power to each of the transmitting antennas 1o, 1f, 1m, and 1r, and transmits the request signal from each of the transmitting antennas 1o, 1f, 1m, and 1r. The transmission controller 2 is an example of the “transmission controller” according to one or more embodiments of the present invention.

When transmitting the request signal from each of the transmitting antennas 1o, 1f, 1m, and 1r, the current detector 3 detects a current passed through each of the transmitting antennas 1o, 1f, 1m, and 1r. The current detector 3 is an example of the “current detector” according to one or more embodiments of the present invention.

The threshold changing part 4 sets a threshold determining the position of the portable device 20 in each of the transmitting antennas 1o, 1f, 1m, and 1r. The threshold changing part 4 changes the threshold in each of the transmitting antennas 1o, 1f, 1m, and 1r based on the current detected by the current detector 3. The threshold changing part 4 is an example of the “threshold changing part” according to one or more embodiments of the present invention.

The controller 20a detects a received signal intensity of the request signal when the reception antenna 20b of the portable device 20 receives the request signal transmitted from each of the transmitting antennas 1o, 1f, 1m, and 1r of the in-vehicle device 10. The controller 20a generates an answer signal including the received signal intensity of each request signal and a reply content, and transmits the answer signal from the transmitting antenna 20c to reply to the in-vehicle device 10. The reply content includes a previously-stored ID of the portable device 20.

When the reception antennas 6o, 6f, 6m, and 6r of the in-vehicle device 10 receive the answer signal sent back from the portable device 20, the portable-device determination part 5 checks the reply content included in the answer signal.

The portable-device determination part 5 matches an ID of the portable device 20 included in the reply content to the previously-stored ID. As a result of the matching, when the IDs are matched to each other, the portable device 20 is authenticated as a registered portable device.

The portable-device determination part 5 compares the received signal intensity of the request signal included in the answer signal to the threshold set by the threshold changing part 4 to determine whether the portable device 20 exists inside or outside the vehicle interior 201 of the vehicle 200. At this point, the portable-device determination part 5 compares the received signal intensity of the request signal to the threshold in each of the transmitting antennas 1o, 1f, 1m, and 1r. The portable-device determination part 5 is an example of the “determination part” according to one or more embodiments of the present invention.

A door locking/unlocking ECU (Electronic Control Unit) (not illustrated) and an engine starting ECU (not illustrated) are notified of the results of the authentication and the positional determination of the portable device 20, which are performed by the portable-device determination part 5. The door locking/unlocking ECU automatically locks and unlocks a door of the vehicle 200 in response to the notification from the portable-device determination part 5. The engine starting ECU permits or inhibits an engine to be started by an operation of push button (not illustrated) in response to the notification from the portable-device determination part 5.

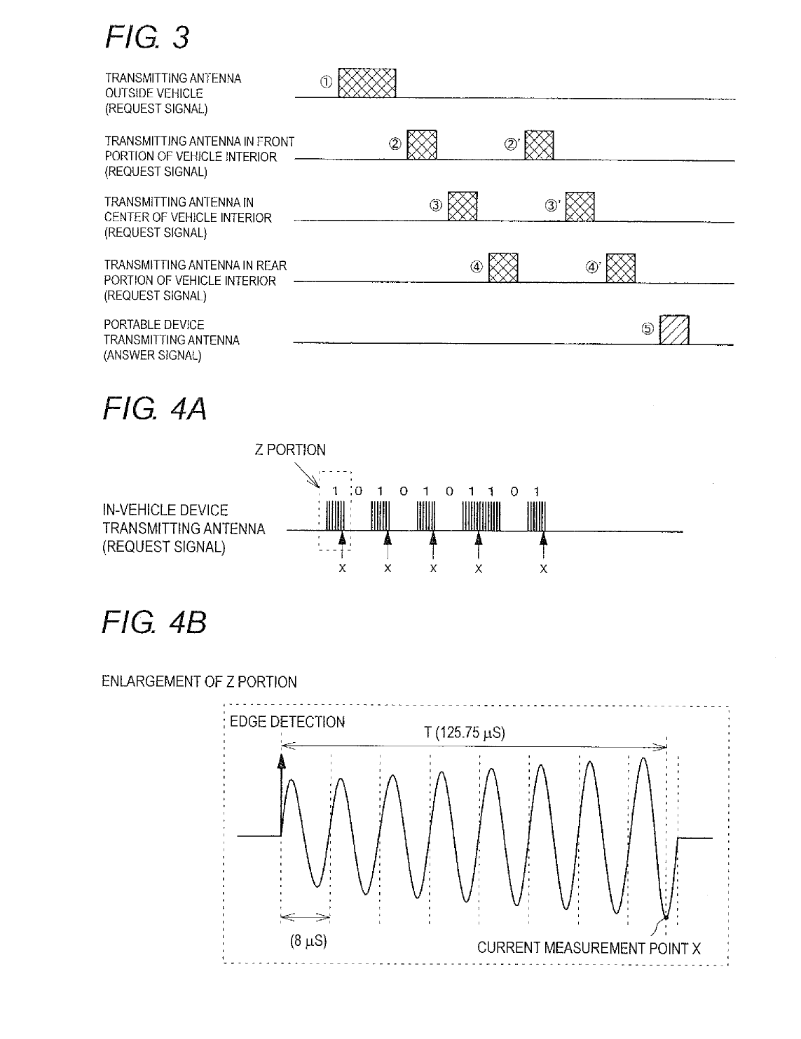

Signal transmission timing of the in-vehicle device 10 and the portable device 20 will be described below with reference to FIG. 3. FIGS. 1 and 2 are also referred to as appropriate.

FIG. 3 is a view illustrating the signal transmission timing of the in-vehicle device 10 and the portable device 20. The transmission controller 2 of the in-vehicle device 10 transmits the request signal to the portable device 20 from the transmitting antenna 1o located outside the vehicle interior 201 (timing of a circled number 1 in FIG. 3).

Then the transmission controller 2 sequentially transmits the request signal to the transmitting antenna if located in the front portion of the vehicle interior 201, the transmitting antenna 1m located in the center, and the transmitting antenna 1r located in the rear portion (timing of each of circled numbers 2, 3, and 4 in FIG. 3). The transmission controller 2 sequentially transmits the request signal to the transmitting antenna 1f, the transmitting antenna 1m, and the transmitting antenna 1r of the vehicle interior 201 again (timing of each of circled numbers 2′, 3′, and 4′ in FIG. 3).

The request signal is transmitted twice from the transmitting antennas 1f, 1m, and 1r. A data length of the request signal from the transmitting antenna 1o is longer than that from the transmitting antennas 1f, 1m, and 1r. Thus, the transmission controller 2 transmits the request signal from the transmitting antennas 1o, 1f, 1m, and 1r in different timing.

After the second-time request signal is transmitted from the transmitting antenna 1r (the circled number 3′ in FIG. 3), the controller 20a of the portable device 20 transmits the answer signal from the transmitting antenna 20c (timing of a circled number 5 in FIG. 3). That is, the portable device 20 sends back the answer signal in the timing of the circled number 5 in FIG. 3 in response to all the request signals from the transmitting antennas 1o, 1f, 1m, and 1r. The transmission timing of the signals from the transmitting antennas 1o, 1f, 1m, 1r and 20c are set so as not to overlap one another.

The controller 20a of the portable device 20 adds information indicating each of the transmitting antennas 1o, 1f, 1m, and 1r of transmission sources to the received signal intensity, which is included in the answer signal, with respect to the request signal from each of the transmitting antennas 1o, 1f, 1m, and 1r. That is, the received signal intensity detected by the portable device 20 with respect to the request signal from each of the transmitting antennas 1o, 1f, 1m, and 1r is sent back to the in-vehicle device 10 while correlated with each of the transmitting antennas 1o, 1f, 1m, and 1r.

Specifically, for example, the controller 20a adds the information indicating the order or the time to receive the request signal to the received signal intensity of the request signal. The transmission controller 2 of the in-vehicle device 10 manages the order or the time to receive the request signal from each of the transmitting antennas 1o, 1f, 1m, and 1r. Therefore, when receiving the answer signal from the portable device 20, the in-vehicle device 10 can determine which one of the transmitting antennas 1o, 1f, 1m, and 1r corresponds to the received signal intensity of the request signal from the additional information included in the answer signal and the management information retained by the transmission controller 2.

In another example, the transmission controller 2 of the in-vehicle device 10 may transmit identification information on each of the transmitting antennas 1o, 1f, 1m, and 1r of the transmission sources while including the identification information in the request signal. In this case, the controller 20a of the portable device 20 may include the identification information on each of the transmitting antennas 1o, 1f, 1m, and 1r of the transmission sources, which is included in the received request signal, in the answer signal while adding the identification information to the received signal intensity of the request signal. Therefore, when receiving the answer signal from the portable device 20, the in-vehicle device 10 can determine which one of the transmitting antennas 1o, 1f, 1m, and 1r corresponds to the received signal intensity of the request signal.

A method for measuring the current passed through each of the transmitting antennas 1o, 1f, 1m, and 1r of the in-vehicle device 10 will be described below with reference to FIGS. 4A-4B. FIG. 1 is also referred to as appropriate.

FIGS. 4A-4B illustrate the signal transmitted from each of the transmitting antennas 1o, 1f, 1m, and 1r and a current measurement point. FIG. 4A illustrates the request signal transmitted from each of the transmitting antennas 1o, 1f, 1m, and 1r. FIG. 4B is an enlarged view of a Z portion in FIG. 4A.

As illustrated in FIG. 4B, a signal waveform in FIG. 4A indicating data “1” of the request signal transmitted from each of the transmitting antennas 1o, 1f, 1m, and 1r vibrates vertically, and an amplitude of the signal waveform increases with time. The amplitude becomes the most stable and the maximum after a substantially given time T (for example, 125.75 μs) elapses from a rising edge of the signal waveform. At this point, the current passed through each of the transmitting antennas 1o, 1f, 1m, and 1r becomes the maximum.

Focusing on this characteristic, the current detector 3 (see FIG. 1) of the in-vehicle device 10 detects the rising edge of the data “1” of the request signal every time the request signal is transmitted from each of the transmitting antennas 1o, 1f, 1m, and 1r. The current value passed through each of the transmitting antennas 1o, 1f, 1m, and 1r is measured after the predetermined time T elapses since the edge is detected (a current measurement point X in FIG. 4B). The processing of measuring the current value is performed predetermined sampling times (the current measurement point X in FIG. 4A), and the maximum value of the current value is detected and output to the threshold changing part 4 (see FIG. 1).

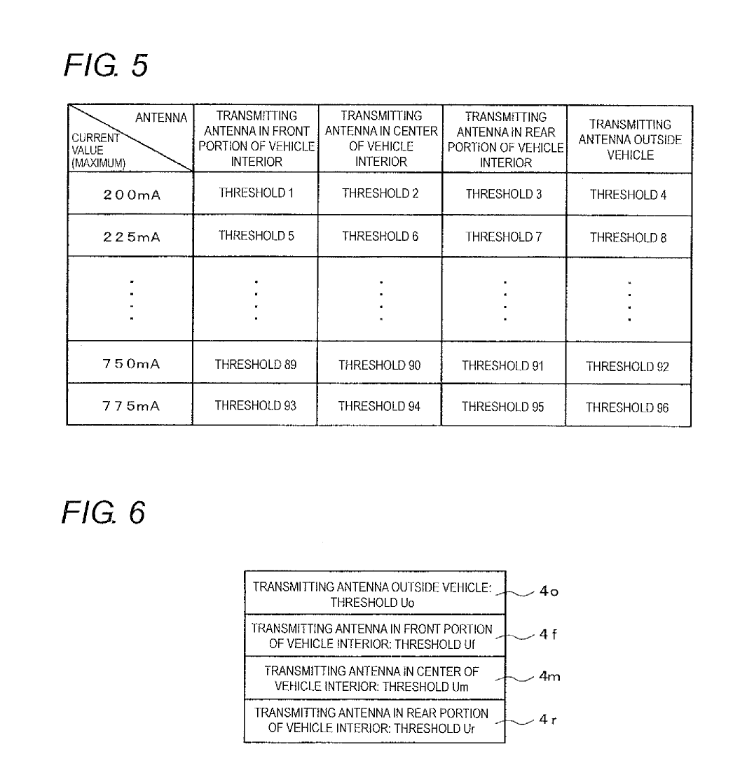

A method for changing a threshold determining the position of the portable device 20 will be described below with reference to FIGS. 5 and 6. FIG. 1 is also referred to as appropriate.

FIG. 5 is a view illustrating a threshold table retained by the in-vehicle device 10. The threshold table is stored in a predetermined area of an internal memory of the threshold changing part 4 (see FIG. 1). In the threshold table, thresholds 1 to 96 determining the position of the portable device 20 are set with respect to the transmitting antennas 1o, 1f, 1m, and 1r while correlated with the maximum value of the current passed in transmitting the request signal of each of the transmitting antennas 1o, 1f, 1m, and 1r. The thresholds 1 to 96 are set based on a previously-performed experimental result.

As illustrated in FIG. 6, with respect to the transmitting antennas 1o, 1f, 1m, and 1r, thresholds Uo, Uf, Um, and Ur are recorded in another predetermined area of the internal memory of the threshold changing part 4. In an initial state, the thresholds Uo, Uf, Um, and Ur are set to an initial value.

When the maximum value of the current detected by the current detector 3 with respect to each of the transmitting antennas 1o, 1f, 1m, and 1r is input, the threshold changing part 4 reads the threshold corresponding to the maximum value from the threshold table (see FIG. 5). In the thresholds Uo, Uf, Um, and Ur, which are recorded in areas 4o, 4f, 4m, and 4r of the internal memory, with respect to the transmitting antennas 1o, 1f, 1m, and 1r, the threshold changing part 4 changes the corresponding threshold to the read threshold.

For example, in the case that “200 mA” is input to the threshold changing part 4 as the maximum value of the current of the transmitting antenna 1o located outside the vehicle interior 201, the “threshold 4” is read from the threshold table in FIG. 5 to change the threshold Uo, which is recorded in the area 4o in FIG. 6, with respect to the transmitting antenna 1o to the “threshold 4”. In the case that “225 mA” is input as the maximum value of the current of the transmitting antenna 1f located in the front portion of the vehicle interior 201, the “threshold 5” is read from the threshold table in FIG. 5 to change the threshold Uf, which is recorded in the area 4f in FIG. 6, with respect to the transmitting antenna if to the “threshold 5”.

In the case that “750 mA” is input as the maximum value of the current of the transmitting antenna 1m located in the center of the vehicle interior 201, the “threshold 90” is read from the threshold table in FIG. 5 to change the threshold Um, which is recorded in the area 4m in FIG. 6, with respect to the transmitting antenna 1m to the “threshold 90”. In the case that “775 mA” is input as the maximum value of the current of the transmitting antenna 1r located in the rear portion of the vehicle interior 201, the “threshold 95” is read from the threshold table in FIG. 5 to change the threshold Ur, which is recorded in the area 4r in FIG. 6, with respect to the transmitting antenna 1r to the “threshold 95”.

When the request signals are transmitted from the transmitting antennas 1o, 1f, 1m, and 1r, the thresholds Uo, Uf, Um, and Ur are changed with respect to the transmitting antennas 1o, 1f, 1m, and 1r based on the maximum values of the currents passed through the transmitting antennas 1o, 1f, 1m, and 1r.

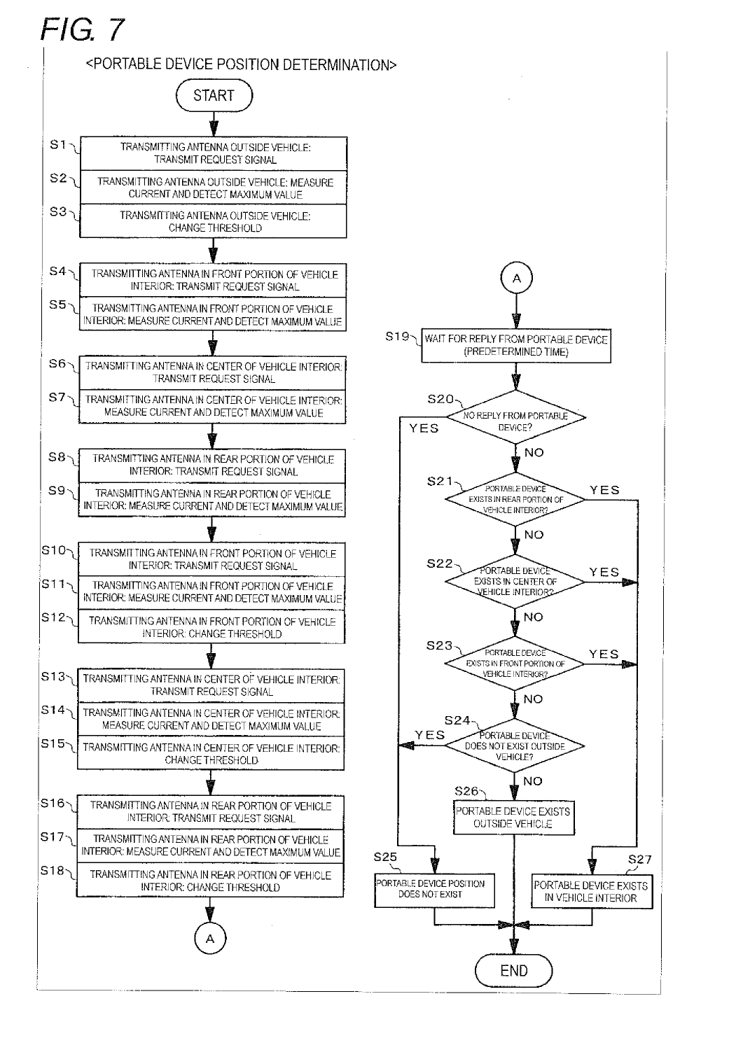

A method for determining the position of the portable device 20 according to one or more embodiments of the present invention will be described below with reference to FIGS. 7 to 9. FIGS. 1, 3, 5, and 6 are also referred to as appropriate.

FIG. 7 is a flowchart illustrating a procedure performed by the in-vehicle device 10 to determine the position of the portable device 20. When a predetermined authentication condition holds, the transmission controller 2 of the in-vehicle device 10 supplies the power to the transmitting antenna 1o located outside the vehicle interior 201, and transmits the request signal from the transmitting antenna 1o (Step S1, the circled number 1 in FIG. 3).

At this point, as illustrated in FIG. 4, the current detector 3 measures the current passed through the transmitting antenna 1o the predetermined sampling times, and detects the maximum value (Step S2 in FIG. 7). When the maximum value of the current detected by the current detector 3 with respect to the transmitting antenna 1o is input, as illustrated in FIGS. 5 and 6, the threshold changing part 4 changes the threshold Uo of the transmitting antenna 1o according to the maximum value (Step S3 in FIG. 7).

After the request signal is transmitted from the transmitting antenna 1o located outside the vehicle interior 201, the transmission controller 2 transmits the request signal twice from the transmitting antennas 1f, 1m, and 1r in the vehicle interior 201 in the order and timing indicated by the circled numbers 2, 3, 4, 2′, 3′, and 4′ in FIG. 3 (Steps S4, S6, S8, S10, S13, and S16).

As illustrated in FIG. 4, every time the first-time request signal is transmitted from each of the transmitting antennas 1f, 1m, and 1r, the current detector 3 measures the current passed through the transmitting antenna 1o the predetermined sampling times, and detects the maximum value (Steps S5, S7, and S9 in FIG. 7). Every time the second-time request signal is transmitted from each of the transmitting antennas 1f, 1m, and 1r, the current detector 3 also measures the current passed through the transmitting antenna 1o the predetermined sampling times. The maximum value is detected from the current values measured during the transmission of the two-time request signal (Steps S11, S14, and S17 in FIG. 7).

Every time the maximum value of the current detected by the current detector 3 with respect to each of the transmitting antennas 1f, 1m, and 1r is input, as illustrated in FIGS. 5 and 6, the threshold changing part 4 changes the thresholds Uf, Um, and Ur of the transmitting antennas if, 1m, and 1r according to the maximum value (Steps S12, S15, and S18 in FIG. 7).

After Step S18, the in-vehicle device 10 waits for the reply from the portable device 20 (Step S19). Unless the answer signal is received from the portable device 20 through the reception antennas 6o, 6f, 6m, and 6r within a predetermined time, the portable-device determination part 5 determines that there is no reply from the portable device 20 (YES in Step S20 in FIG. 7). The portable-device determination part 5 determines that the portable device 20 does not exist near the vehicle 200 (out of a detection range) (Step S25).

On the other hand, after Step S18, when the answer signal is transmitted from the portable device 20 in the timing indicated by the circled number 5 in FIG. 3, the reception antennas 6o, 6f, 6m, and 6r receive the answer signal within the predetermined time. Therefore, the portable-device determination part 5 determines that there is the reply from the portable device 20 (NO in Step S20 in FIG. 7).

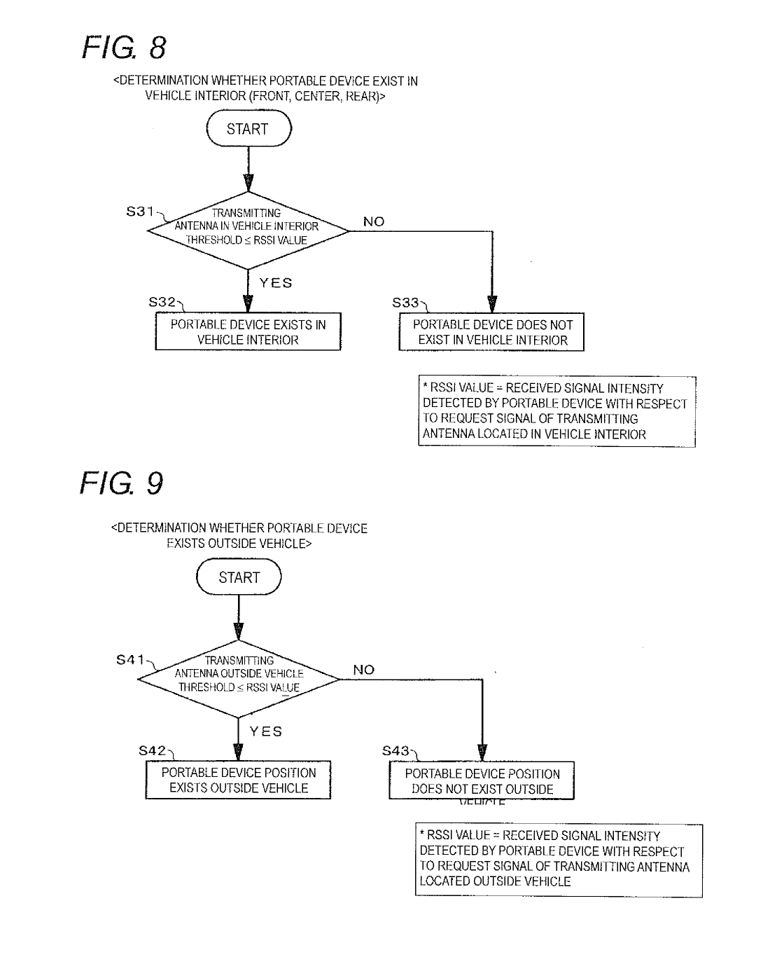

The portable-device determination part 5 determines whether the portable device 20 exists in the rear portion of the vehicle interior 201 (Step S21 in FIG. 7). The determination is made according to a procedure to determine whether the portable device exists in the vehicle interior as illustrated in FIG. 8. Referring to FIG. 8, the received signal intensity (RSSI value), which is included in the received answer signal, with respect to the request signal of the transmitting antenna 1r is compared to the threshold Ur that is set by the threshold changing part 4 with respect to the transmitting antenna 1r. When the received signal intensity of the request signal of the transmitting antenna 1r is equal to or greater than the threshold Ur (YES in Step S31 in FIG. 8), the portable-device determination part 5 determines that the portable device 20 exists in the rear portion of the vehicle interior 201 (Step S32 in FIG. 8 and YES in Step S21 in FIG. 7). The portable-device determination part 5 determines that the portable device 20 exists in the vehicle interior 201 (Step S27 in FIG. 7).

On the other hand, when the received signal intensity of the request signal of the transmitting antenna 1r is less than the threshold Ur (NO in Step S31 in FIG. 8), the portable-device determination part 5 determines that the portable device 20 does not exist in the rear portion of the vehicle interior 201 (Step S33 and NO in Step S21 in FIG. 7). Similarly, through the same procedure as FIG. 8, the portable-device determination part 5 determines whether the portable device 20 exists in the center of the vehicle interior 201 (Step S22 in FIG. 7).

At Step S31 in FIG. 8, when the received signal intensity, which is included in the answer signal, with respect to the request signal of the transmitting antenna 1m is equal to or greater than the threshold Um set by the threshold changing part 4 with respect to the transmitting antenna 1m (YES in Step S31), the portable-device determination part 5 determines that the portable device 20 exists in the center of the vehicle interior 201 (Step S32 in FIG. 8 and YES in Step S22 in FIG. 7). The portable-device determination part 5 determines that the portable device 20 exists in the vehicle interior 201 (Step S27 in FIG. 7).

On the other hand, at Step S31 in FIG. 8, when the received signal intensity of the request signal of the transmitting antenna 1m is less than the threshold Um (NO in Step S31), the portable-device determination part 5 determines that the portable device 20 does not exist in the center of the vehicle interior 201 (Step S33 and NO in Step S22 in FIG. 7). Similarly, through the same procedure as FIG. 8, the portable-device determination part 5 determines whether the portable device 20 exists in the front portion of the vehicle interior 201 (Step S23 in FIG. 7).

At Step S31 in FIG. 8, when the received signal intensity, which is included in the answer signal, with respect to the request signal of the transmitting antenna if is equal to or greater than the threshold Uf set by the threshold changing part 4 with respect to the transmitting antenna 1f, (YES in Step S31), the portable-device determination part 5 determines that the portable device 20 exists in the front portion of the vehicle interior 201 (Step S32 in FIG. 8 and YES in Step S23 in FIG. 7). The portable-device determination part 5 determines that the portable device 20 exists in the vehicle interior 201 (Step S27 in FIG. 7).

On the other hand, at Step S31 in FIG. 8, when the received signal intensity of the request signal of the transmitting antenna 1f is less than the threshold Uf (NO in Step S31), the portable-device determination part 5 determines that the portable device 20 does not exist in the front portion of the vehicle interior 201 (Step S33 and NO in Step S23 in FIG. 7). Therefore, because the portable device 20 does not exist in any positions of the vehicle interior 201, the portable-device determination part 5 determines whether the portable device 20 exists outside the vehicle interior 201 (however, within the detection range) (Step S24 in FIG. 7). The determination is made according to a procedure to determine whether the portable device exists outside the vehicle interior as illustrated in FIG. 9.

Referring to FIG. 9, the received signal intensity, which is included in the received answer signal, with respect to the request signal of the transmitting antenna 1o is compared to the threshold Uo that is set by the threshold changing part 4 with respect to the transmitting antenna 1o. When the received signal intensity (RSSI value) of the request signal of the transmitting antenna 1o is equal to or greater than the threshold Uo (YES in Step S41 in FIG. 9), the portable-device determination part 5 determines that the portable device 20 exists outside the vehicle interior 201 (Step S42 in FIG. 9 and NO in Step S24 in FIG. 7). The portable-device determination part 5 determines that the portable device 20 exists outside the vehicle interior 201 (Step S26 in FIG. 7).

On the other hand, when the received signal intensity of the request signal of the transmitting antenna 1o is less than the threshold Uo (NO in Step S41 in FIG. 9), the portable-device determination part 5 determines that the portable device 20 does not exist outside the vehicle interior 201 (Step S43 in FIG. 9 and YES in Step S24 in FIG. 7). The portable-device determination part 5 determines that the portable device 20 does not exist near the vehicle 200 (out of the detection range) (Step S25 in FIG. 7).

Due to physical factors such as a change in ambient temperature and variations in characteristic/accuracy of the transmitting antennas 1o, 1f, 1m, and 1r and a circuit element, the currents passed through the transmitting antennas 1o, 1f, 1m, and 1r change to vary the received signal intensity of the request signal detected by the portable device 20 in some cases.

On the other hand, in one or more embodiments of the present invention, the in-vehicle device 10 compares the received signal intensity of the request signal detected by the portable device 20 to the threshold that is changed according to the current passed through each of the transmitting antennas 1o, 1f, 1m, and 1r during the transmission of the request signal. The position of the portable device 20 is determined with respect to the vehicle 200 from the comparison result, so that position determination accuracy of the portable device 20 can be improved without influences of the physical factors.

In one or more embodiments of the present invention, the thresholds Uo, Uf, Um, and Ur are set to the transmitting antennas 1o, 1f, 1m, and 1r installed inside and outside the vehicle interior 201 of the vehicle 200, respectively, and the thresholds Uo, Uf, Um, and Ur are changed according to the currents passed through the transmitting antennas 1o, 1f, 1m, and 1r during the transmission of the request signal. The received signal intensity of the request signal detected by the portable device 20 is compared to the threshold in each of the transmitting antennas 1o, 1f, 1m, and 1r, so that the accuracy of the determination that the portable device 20 exists inside or outside the vehicle interior 201 can be improved.

In one or more embodiments of the present invention, during the transmission of the request signal, the thresholds Uo, Uf, Um, and Ur of the transmitting antennas 1o, 1f, 1m, and 1r are changed according to the maximum values of the currents passed through the transmitting antennas 1o, 1f, 1m, and 1r. Therefore, the thresholds Uo, Uf, Um, and Ur can be set according to the changes in currents of the transmitting antennas 1o, 1f, 1m, and 1r due to the physical factors.

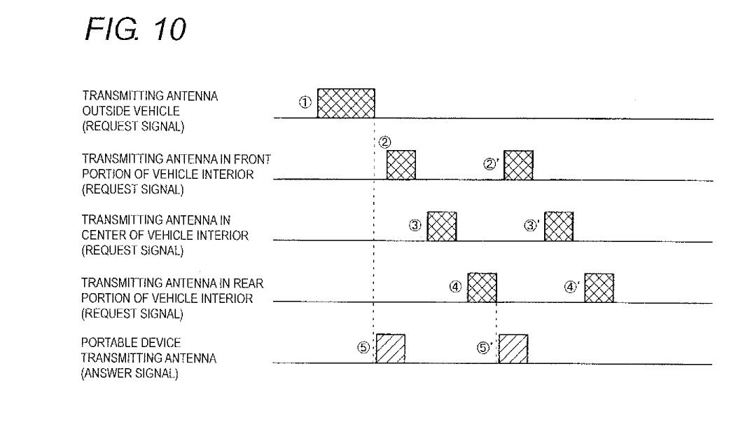

Various embodiments can be made in addition to the above embodiments. In one or more embodiments of the present invention, as illustrated in FIG. 3, by way of example, the portable device 20 sends back the answer signal after the request signal is transmitted once or twice from the transmitting antennas 1o, 1f, 1m, and 1r of the in-vehicle device 10. Alternatively, for example, the portable device 20 may send back the answer signal immediately after the request signal is received from any one of the transmitting antennas 1o, 1f, 1m, and 1r like the timing indicated by the circled number 5 or 5′ in FIG. 10.

In this case, the portable device 20 may send back the answer signal such that a one-on-one relationship holds for all the request signals received by the portable device 20. When the in-vehicle device 10 receives the answer signal, the first-time request signal is not transmitted from the transmitting antennas 1f, 1m, and 1r since then, but the transmission of the second-time request signal may immediately be started from the transmitting antennas 1f, 1m, and 1r. Therefore, a processing speed of the position determination of the portable device 20 can be enhanced.

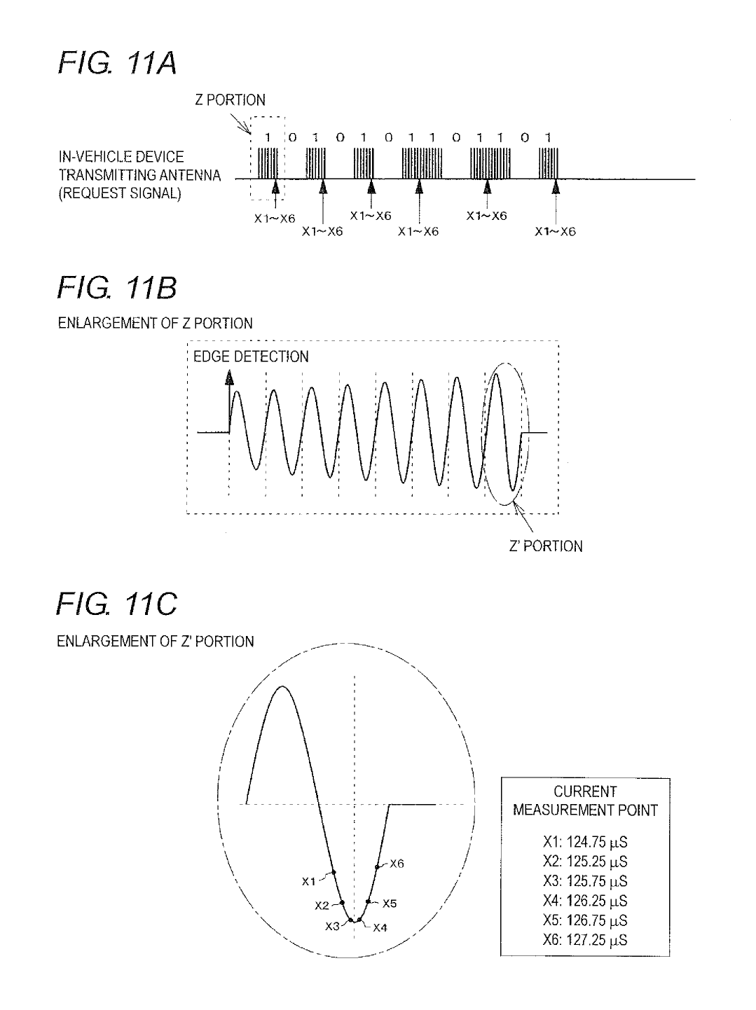

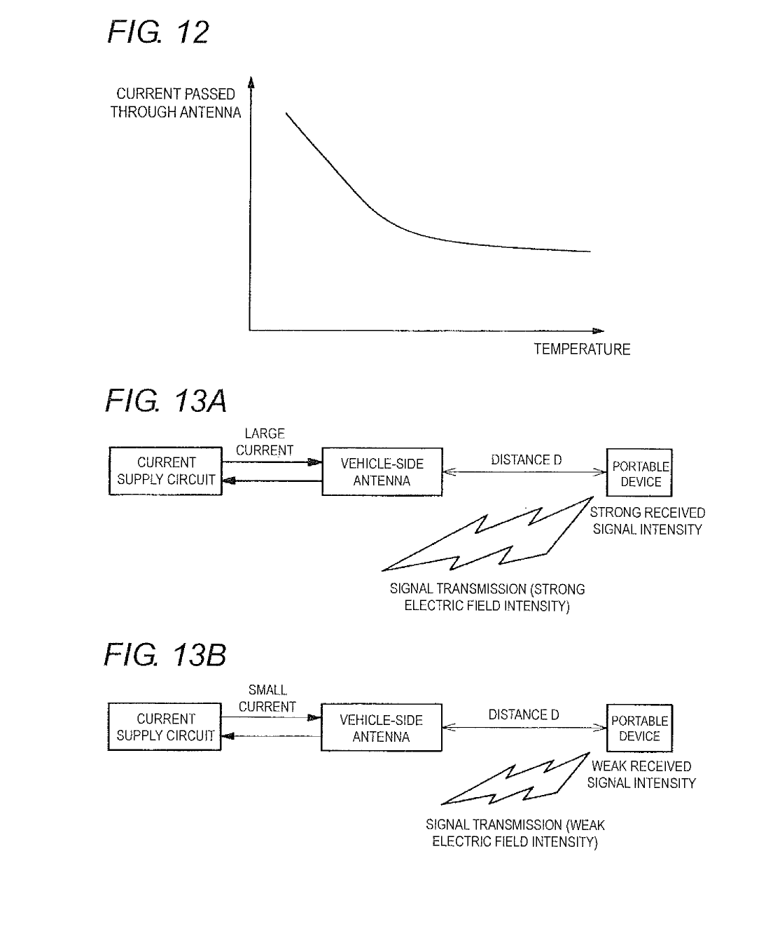

In one or more embodiments of the present invention, as illustrated in FIG. 4, by way of example, the currents passed through the transmitting antennas 1o, 1f, 1m, and 1r are measured at the point X after the predetermined time T elapses since the rising edge of the data “1” of the request signal is detected. Alternatively, for example, as illustrated in FIGS. 11A-11C, the currents passed through the transmitting antennas 1o, 1f, 1m, and 1r may be measured at a plurality of points X1 to X6 after a predetermined time elapses since the rising edge of the data “1” of the request signal is detected. FIG. 11B is an enlarged view of the Z portion in FIG. 11A, and FIG. 11C is an enlarged view of the Z′ portion in FIG. 11B.

In FIGS. 11A-11C, assuming that X1 is a starting point X1 after 124.75 is elapses since the rising edge is detected, and that X2 to X6 are the subsequent points to 127.25 ms at intervals of 0.5 μs, the current passed through each of the transmitting antennas 1o, 1f, 1m, and 1r is measured at the total of six points. The processing of measuring the current is performed to predetermined sampling times (for example, six times) as illustrated in FIG. 11A, and the maximum value in all the measured values is detected and output to the threshold changing part 4 (see FIG. 1). Therefore, the detection accuracy of the maximum value of the current passed through each of the transmitting antennas 1o, 1f, 1m and 1r can be improved during the transmission of the request signal.

Alternatively, instead of detecting the maximum value of the current passed through each of the transmitting antennas 1o, 1f, 1m, and 1r by measuring the current at the plurality of points as illustrated in FIGS. 11A-11C, the maximum value of the current passed through each of the transmitting antennas 1o, 1f, 1m, and 1r may be detected with a peak hold circuit in which a capacitor is used.

In one or more embodiments of the present invention, as illustrated in FIGS. 3 and 7, by way of example, the request signal is sequentially transmitted once or twice from the transmitting antennas 1o, 1f, 1m, and 1r. Alternatively, the request signal may be transmitted from the transmitting antennas 1o, 1f, 1m, and 1r in the order other than described above, or the number of times other than described above. The current passed through each of the transmitting antennas 1o, 1f, 1m, and 1r may be detected every time the request signal is transmitted or one out of two times the request signal is transmitted. The current may be detected one out of several times the request signal is transmitted.

In one or more embodiments of the present invention, as illustrated in FIG. 7, existence of the portable device 20 is sequentially determined in the rear portion of the vehicle interior 201, the center of the vehicle interior 201, the front portion of the vehicle interior 201, and outside the vehicle interior 201. Alternatively, existence of the portable device 20 may be determined in the order other than described above.

In one or more embodiments of the present invention, the three transmitting antennas 1f, 1m, and 1r are provided in the vehicle interior 201 of the vehicle 200, and the one transmitting antenna 1o is provided outside the vehicle interior 201. Alternatively, one or four transmitting antennas may be provided in the vehicle interior 201 while the plurality of transmitting antennas are provided outside the vehicle interior 201.

Above, one or more embodiments of the present invention is applied to the position determination system 100 that determines the position of the portable device 20 inside or outside the vehicle interior 201 in order to lock/unlock the door of the vehicle 200 or to control the starting of the engine. One or more embodiments of the present invention can also be applied to the portable-device position determination system that determines the position of the portable device in applications other than the position determination system 100.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A portable-device position determination system comprising:
a portable device that is configured to be possessed by a user; and
an in-vehicle device that is mounted on a vehicle and conducts wireless communication with the portable device,
wherein the in-vehicle device transmits a request signal to the portable device,
wherein the portable device detects a received signal intensity of the request signal to send back the received signal intensity to the in-vehicle device,
wherein the in-vehicle device compares the received signal intensity of the request signal detected by the portable device to a threshold to determine a position of the portable device,
wherein the in-vehicle device includes:
a transmission controller that generates the request signal, supplies an electric power to a transmitting antenna, and transmits the request signal from the transmitting antenna;
a current detector that detects a current passed through the transmitting antenna when the request signal is transmitted; and
a threshold changing part that changes the threshold based on the current detected by the current detector.

2. The portable-device position determination system according to claim 1,
wherein the transmitting antennas are installed inside and outside the vehicle,
wherein the transmission controller supplies the electric power to each of the transmitting antennas, and transmits the request signal from each of the transmitting antennas in different timing,
wherein the current detector detects the current passed through each of the transmitting antennas when the request signal is transmitted from each of the transmitting antennas,
wherein the threshold changing part changes the threshold in each of the transmitting antennas based on the current detected by the current detector,
wherein the portable device detects the received signal intensity of the request signal transmitted from each of the transmitting antennas, and sends back the received signal intensity to the in-vehicle device while correlating the received signal intensity with each of the transmitting antenna, and
wherein the in-vehicle device further includes a determination part that compares the received signal intensity of the request signal to the threshold in each of the transmitting antennas to determine whether the portable device exists inside or outside the vehicle.

3. The portable-device position determination system according to claim 1, wherein the current detector detects the current passed through each of the transmitting antennas every time the request signal is transmitted from each of the transmitting antennas.

4. A portable-device position determination method in which an in-vehicle device mounted on a vehicle conducts wireless communication with a portable device possessed by a user to transmit a request signal to the portable device, comprising:
detecting via the portable device a received signal intensity of the request signal to send back the received signal intensity to the in-vehicle device;
comparing via the in-vehicle device the received signal intensity of the request signal detected by the portable device to a threshold to determine a position of the portable device;
generating via the in-vehicle device the request signal;
supplying via the in-vehicle device an electric power to a transmitting antenna;
transmitting via the in-vehicle device the request signal from the transmitting antenna;
detecting via the in-vehicle device a current passed through the transmitting antenna when the request signal is transmitted; and
changing via the in-vehicle device the threshold based on the detected current.

5. The portable-device position determination method according to claim 4,
wherein the transmitting antennas are installed inside and outside the vehicle,
wherein the in-vehicle device:
supplies the electric power to each of the transmitting antennas, and transmits the request signal from each of the transmitting antennas in different timing,
detects the current passed through each of the transmitting antennas when the request signal is transmitted from each of the transmitting antennas, and
changes the threshold in each of the transmitting antennas based on the detected current,
the portable device detects the received signal intensity of the request signal transmitted from each of the transmitting antennas, and sends back the received signal intensity to the in-vehicle device while correlating the received signal intensity with each of the transmitting antenna, and
the in-vehicle device compares the received signal intensity of the request signal to the threshold in each of the transmitting antennas to determine whether the portable device exists inside or outside the vehicle.

6. The portable-device position determination method according to claim 4, wherein the in-vehicle device detects the current passed through each of the transmitting antennas every time the request signal is transmitted from each of the transmitting antennas.

7. A portable-device position determination apparatus that is of an in-vehicle device mounted on a vehicle,
wherein the portable-device position determination apparatus:
conducts wireless communication with a portable device configured to be possessed by a user to transmit a request signal to the portable device,
receives a received signal intensity of the request signal detected by the portable device from the portable device, and
compares the received signal intensity to a threshold to determine a position of the portable device,
wherein the portable-device position determination apparatus comprises:
a transmission controller that generates the request signal, supplies an electric power to a transmitting antenna, and transmits the request signal from the transmitting antenna;
a current detector that detects a current passed through the transmitting antenna when the request signal is transmitted; and
a threshold changing part that changes the threshold based on the current detected by the current detector.

8. The portable-device position determination apparatus according to claim 7,
wherein the transmitting antennas are installed inside and outside the vehicle,
wherein the transmission controller transmits the request signal from each of the transmitting antennas in different timing,
wherein the current detector detects the current passed through each of the transmitting antennas when the request signal is transmitted from each of the transmitting antennas,
wherein the threshold changing part changes the threshold in each of the transmitting antennas based on the current detected by the current detector, and
wherein the portable-device position determination apparatus further includes a determination part that compares the received signal intensity of the request signal to the threshold in each of the transmitting antennas to determine whether the portable device exists inside or outside the vehicle.

9. The portable-device position determination apparatus according to claim 7, wherein the current detector detects the current passed through each of the transmitting antennas every time the request signal is transmitted from each of the transmitting antennas.

10. The portable-device position determination apparatus according to claim 7,
wherein the current detector detects a maximum value of the current passed through the transmitting antenna during the transmission of the request signal, and
wherein the threshold changing part changes the threshold based on the maximum value of the current detected by the current detector.
